(19) United States
(12) Patent Application Publication
(10) Pub. No.: US 2025/0106051 A1
(43) Pub. Date: Mar. 27, 2025

(54) DECENTRALIZED COMPUTING CAPABILITIES WITH FUNCTIONS AND AUTOMATION

(71) Applicant: SmartContract Chainlink Limited SEZC, Grand Cayman (KY)

(72) Inventors: Akshay Aggarwal, Grand Cayman (KY); Marthinus Coenraad De Clercq Wentzel, Grand Cayman (KY); Ryan Robert Hall, Grand Cayman (KY); Amir Yahalom, Grand Cayman (KY); Anirudh Ajith Warrier, Grand Cayman (KY); Kejin Fan, Grand Cayman (KY); Christopher Malec, Grand Cayman (KY); Lei Shi, Grand Cayman (KY); Oliver Griswold Townsend, Grand Cayman (KY); Vlad Ghelesel, Grand Cayman (KY); Fergal Patrick Gribben, Grand Cayman (KY)

(73) Assignee: SmartContract Chainlink Limited SEZC, Grand Cayman (KY)

(21) Appl. No.: 18/898,270

(22) Filed: Sep. 26, 2024

Related U.S. Application Data
(60) Provisional application No. 63/540,874, filed on Sep. 27, 2023.

(51) Int. Cl. H04L 9/00

(52) U.S. Cl. CPC H04L 9/50

(57) ABSTRACT

Systems, devices, and methods provide for smart contract automation for triggering smart contract functions. The smart contract automation may receive log data, provide an upkeep payload to a workflow, the upkeep payload comprising one or more active upkeeps. The smart contract automation may determine, by the proposal workflow, whether the one or more active upkeeps is an eligible upkeep. The smart contract automation may determine, by the smart contract automation system, a reportable result based on the eligible upkeep and the log data. The smart contract automation may transmit the reportable result to a blockchain.

### CROSS-REFERENCE TO RELATED APPLICATION

This application claims priority to, and the benefit of, U.S. Provisional Patent Application No. 63/540,874 filed Sep. 27, 2023 and entitled “Decentralized Computing Capabilities With Functions and Automation.” The foregoing application is hereby incorporated by reference herein, but except for any subject matter disclaimers or disavowals, and except to the extent that the incorporated material is inconsistent with the express disclosure herein, in which case the language in this disclosure shall control.

### TECHNICAL FIELD

This disclosure is in the field of distributed systems, and in particular the field of decentralized execution engines for automating smart contracts with a triggering mechanism.

### BACKGROUND

Prior approaches for processing data using a blockchain system have suffered from various limitations, for example limitations related to accuracy and efficiency in verifying data. Accordingly, systems and methods offering improvements thereto remain highly desirable.

### SUMMARY

In an exemplary embodiment, a smart contract automation system comprises one or more processors configured by machine-readable instructions to: receive, by the smart contract automation system, a log data; provide, by an upkeep provider, an upkeep payload to a workflow, the upkeep payload comprising one or more active upkeeps; determine, by the proposal workflow, whether the one or more active upkeeps is an eligible upkeep; determine, by the smart contract automation system, a reportable result based on the eligible upkeep and the log data; and transmit, by the smart contract automation system, the reportable result to a blockchain.

In another exemplary embodiment, a method of smart contract automation, comprises: triggering, by a processor, a conditional trigger based on a condition of a blockchain; receiving, by the processor, a verifiable data in response to the conditional trigger; determining, by the processor, a recordable transaction based on the verifiable data; agreeing, by the processor and a processor of one or more nodes in a network of nodes, the recordable transaction is agreed to; and executing, by the processor, a smart contract, wherein the smart contract is based on the recordable transaction.

In another exemplary embodiment, a smart contract automation system comprises: a processor; and a tangible, non-transitory memory configured to communicate with the processor, the tangible, non-transitory memory having instructions stored thereon that, in response to execution by the processor, cause the processor to perform operations comprising: polling, by a log poller, a log data associated with a blockchain; storing, by the log poller, the log data in a database; determining, by one or more workflows, a performable event based on the log data; agreeing, by one or more nodes, a reportable result based on the performable event; and recording the reportable result on the blockchain.

### BRIEF DESCRIPTION OF THE DRAWINGS

The accompanying drawings are included to provide a further understanding of the present disclosure and are incorporated in, and constitute a part of, this specification, illustrate various exemplary embodiments, and together with the description, serve to explain exemplary principles of the disclosure.

FIG. 1 illustrates a decentralized execution engine for automating smart contracts with a triggering mechanism, in accordance with various exemplary embodiments;

FIG. 2 illustrates a decentralized execution engine for automating smart contracts with a triggering mechanism, in accordance with various exemplary embodiments; and

FIG. 3 illustrates an exemplary smart contract automation system and blockchain, in accordance with various exemplary embodiments.

### DETAILED DESCRIPTION

The detailed description of various exemplary embodiments herein makes reference to the accompanying drawings, which show various exemplary embodiments by way of illustration. While these various exemplary embodiments are described in sufficient detail to enable those skilled in the art to practice the disclosure, it should be understood that other embodiments may be realized and that structural, logical, and/or similar changes may be made without departing from the spirit and scope of the disclosure. Thus, the detailed description herein is presented for purposes of illustration and not of limitation.

For example, steps recited in any of the method or process descriptions may be executed in any suitable order and are not necessarily limited to the order presented. Furthermore, any reference to singular may include plural embodiments, and any reference to more than one component or step may include a singular embodiment or step.

In various exemplary embodiments, a smart contract execution automation system may use triggers to identify when a process should be performed. The smart contract execution automation system may process and verify transactions and in turn execute smart contracts to the blockchain. In that regard, the present disclosure relates to various systems, devices, and methods for automating smart contracts using a decentralized execution engine with a triggering mechanism.

In various exemplary embodiments, a smart contract automation system may be implemented using a smart contract automation protocol. The smart contract automation protocol may include, for example, an Off Chain Reporting (OCR) function such as an OCR3 interface. The OCR3 interface may also be referred to herein as an OCR Interface, OCR plugin, or more generally as just “plugin.” In various exemplary embodiments, a plugin may receive performables, reports, or a variety of other data, and may transmit results or performables to a blockchain. In various exemplary embodiments, a smart contract automation protocol may comprise a decentralized consensus framework for off-chain computation. In various exemplary embodiments, a smart contract automation system may comprise off-chain components, and on-chain contracts. The term “off-chain” may be used to refer to a computation, event, or other data processing or transmission that occurs outside a blockchain. The term “on-chain” may refer to a computation, event, or other data processing or transmission that occurs at least partially on or by a blockchain.

In various exemplary embodiments, the smart contract automation system may comprise one or more nodes which form a peer-to-peer network using a smart contract automation protocol, such as the Chainlink OCR3 protocol. The one or more nodes may use a registry to determine which upkeeps to service and simulate check upkeep functions on their own block nodes to determine when upkeeps are eligible to be performed. Using the smart contract automation protocol, nodes may reach consensus on which upkeeps to perform and sign a report that may contain the performData that will be executed on-chain. The report may be validated on the registry on-chain before execution to provide cryptographic guarantees. The smart contract automation system comprises built-in redundancy and will still perform upkeep checks even if some nodes are down. A benefit that can be appreciated is the smart contract automation protocol and system enable a hyper-reliable automation service that can execute and confirm transactions even during intense gas spikes or on chains with significant reorgs. Further, individual nodes of the smart contract automation system do not compete with each other, but rather work together to ensure all registered upkeeps are performed. This makes the cost to complete a transaction and record on the chain more predictable upfront, enabling estimation of costs based on the expected gas consumption. Gas is a measure of how much it costs to complete a transaction on the blockchain, or more generally the costs associated with each step of the processing associated with a verification related to blockchain.

In various exemplary embodiments, a smart contract automation system may comprise one or more triggers. Triggers may include, for example, conditional triggers and/or log triggers. In various exemplary embodiments, conditional triggers may be based on on-chain conditions as specified by the logic in the upkeep smart contract, e.g., time elapsed since last execution exceeding some specified threshold. In various exemplary embodiments, conditions may be checked periodically, and if the conditions are met, a transaction is sent to execute some work. Log triggers are based on arbitrary event logs that were emitted on-chain, e.g., a new token transfer emits an event log. However, any suitable trigger may be utilized, as desired. It can be appreciated that information regarding logs and log event triggers may be referred to herein as “log data.”

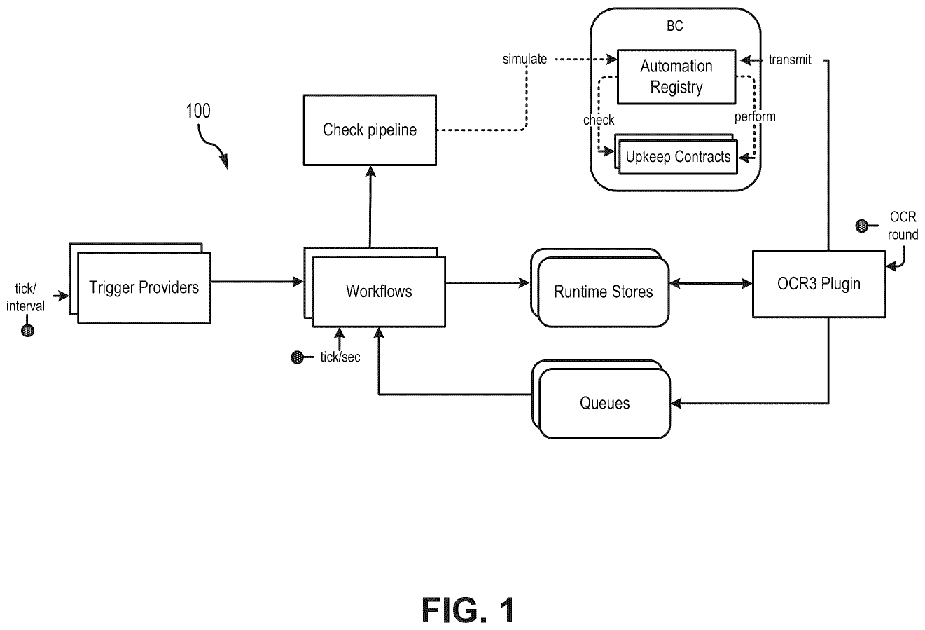

As shown with reference now to FIG. 1, an exemplary smart contract automation system 100 is shown in accordance with various exemplary embodiments. Smart contract automation system 100 may be implemented using a smart contract automation protocol or “protocol.” Smart contract automation system 100 may comprise upkeeps and one or more nodes. In various exemplary embodiments, upkeeps may be registered through an on-chain registry. The nodes may sync the upkeeps to their local state. The nodes may listen to external events, and may trigger the checking of upkeeps based on those events. In various embodiments, smart contract automation system 100 may comprise eligible results, such as performables, with ceiling ((n+f+1)/2) nodes reaching the same performable and f+1 nodes signing a report containing the performable, which may be performed on-chain. Upkeeps which need coordination on a latest check block are considered as proposals and will go through additional workflow before the eligible ones become performables. Moreover, a smart contract automation protocol may run additional threads to scan for missed events, to ensure the integrity of the system.

In various exemplary embodiments, smart contract automation system 100 comprises one or more off-chain components, which may be configured to perform one or more of the following: State management—keeping track of the state of the system, including upkeeps, triggers, and results;

Watching triggers—listening to external events and triggering the execution of smart contracts based on those events:

Eligibility workflows—determining whether an upkeep and trigger (for example, “upkeep+trigger”) is eligible to perform based on check pipeline which is parameterized by a check block number and user supplied callData for conditional triggers, or log event data for log triggers to do on-chain remote procedure call (“RPC”) simulations;

Byzantine Quorum—ceiling ((n+f+1)/2) nodes reaching the same conclusion on which upkeeps should be performed and their perform Data;

Signed Report—f+1 nodes signing a report that says which upkeeps will be performed based on quorum reached; and

Execution—executing the agreed, eligible upkeeps on-chain.

In various exemplary embodiments, the smart contract automation protocol may work with n=10 nodes, handling up to f=3 arbitrary malicious nodes (although these numbers can be set based on desired security guarantees, for example as per Chainlink OCR3 protocol). The smart contract automation protocol may work with between about 7 (minimum is ceiling ((n+f+1)/2) nodes and 10 nodes (max is n). Moreover, the smart contract automation protocol may aim to provide guarantees, such as reliability guarantees and security guarantees. For example, reliability guarantees may include log triggers and or conditional triggers.

In various exemplary embodiments, smart contract automation system 100 may comprise log triggers, also referred to as log trigger upkeeps. For example, a log trigger may occur where out of n=10 nodes, with f=3, every node listens to configured user log, as soon as ceiling ((n+f+1)/2)=7 nodes observe the log and agree on a checkPipeline result, it will be performed on-chain.

In another example, smart contract automation system 100 may comprise conditionals, also referred to herein as conditional upkeeps For example, a conditional may include an arrangement where every upkeep's condition will be checked at least once by the network approximately every 3 seconds (or about every 2 seconds, or about every 4 seconds), handling up to f=3 nodes being down. Once a condition is eligible, every node evaluates the checkPipeline on a coordinated check block; as soon as ceiling ((n+f+1)/2)=7 nodes agree, it will be performed on chain. The smart contract automation system 100 and protocol may be functional as long as at least ceiling ((n+f+1)/2)=7 nodes are alive and participating within a peer to peer network (for example, as required for OCR3 consensus).

In various exemplary embodiments, the security guarantees may include where at least ceiling ((n+f+1)/2)=7 independent nodes need to achieve agreement on an upkeep, trigger and its data and f+1=4 nodes need to sign the report before it is performed.

In various exemplary embodiments, smart contract automation system 100 may comprise various parameters sent and received by the components of the system. The following are a list of several identifiers or parameters used by the smart contract automation system 100.

UpkeepID—Unique 256 bit identifier for an upkeep. Each upkeep has a unique trigger type (conditional or log) which is encoded within the ID. In various embodiments, the ID may be approximately 256 bits.

Trigger—Used to represent the trigger for a particular upkeep performance, and is represented as→(checkBlockNum, checkBlockHash, extension). The extension is based on the trigger type: Conditionals: no extension; Log triggers→(logTxHash, logIndex, logBlockHash, logBlockNum). Of note, logBlockNum might not be present in the trigger. In such cases the log block will be resolved the given block hash.

LogIdentifier—Unique identifier for a log→(logBlockHash, logTxHash, logIndex).

WorkID—Unique 256 bit identifier for a unit of work that is used across the system. (upkeepID, trigger) are used to form a workID, in different structure, based on the trigger type: Conditionals: keccak256 (upkeepID). Where sequential execution of the same upkeepID is allowed, in cases the trigger has a newer checkBlockNum, higher than the last performed block. Log triggers: keccak256 (upkeepID,logIdentifier) It will be appreciated that, at any point in time, there can be at most one unit of work for a particular upkeep and log.

UpkeepPayload—Input information to process a unit of work for an upkeep→(upkeepID, trigger, triggerData). For conditionals triggerData is empty (derived onchain in checkUpkeep). For log: triggerData is the log information.

UpkeepResult—Output information to perform an upkeep. Same for both types→(fastGasWei, linkNative, upkeepID, trigger, gasLimit, performData).

### Providers

In various exemplary embodiments, smart contract automation system 100 may comprise one or more providers, for example including an upkeep provider, a log event provider, and/or a log event recorder. Providers may act as data source(s) of triggers to the protocol. Each provider serves a different workflow and is responsible for providing the corresponding payloads.

In various exemplary embodiments, the upkeep provider may be responsible for providing upkeep payloads to the conditional proposal workflow. The upkeep provider may provide a list of active upkeeps to be sampled.

In various exemplary embodiments, an upkeep sampler may sample the conditional proposal workflow. For example, the upkeep sampler may sample the conditional proposal workflow to determine upkeeps that should be reviewed or checked.

In various exemplary embodiments, log data may be fetched or received by a log poller. The log poller may store log events or other log data in a database (DB). The log poller may filter the log event data based on one or more log filters. The log poller may provide the log event data to other modules, such as the log event recoverer, and/or log event provider based on the filtering.

In various exemplary embodiments, the log event provider may be responsible for collecting latest logs. The log event provider may provide the payloads to the log trigger workflow. The log event provider works on the following window/range of blocks: [latestBlock, latestBlock-lookbackBlocks]. In some exemplary embodiments, lookbackBlocks is 200 blocks and equal or higher than the chain's finality depth. The log event provider may read logs from the log poller. The log event provider may store the log data in the log buffer. The log event provider may continuously read and receive log data in the background and store log data once pre upkeep in the log buffer. The log buffer may be queried by the log observer (preprocessor) for latest logs without input, i.e., with no range or any indication for desired upkeeps. The log buffer may ensure that logs will be kept for a certain amount of time, and to be visited/seen only once.

In various exemplary embodiments, the log event recoverer may be responsible for collecting logs that were missed or dropped by the log event provider. The log event recoverer may also be referred to as the log recoverer. The log event recoverer may provide the corresponding payloads to the log recovery proposal workflow. For example, the log recoverer may re-scan log data and send missed logs to the recovery workflow, such as the log recovery proposal workflow. In addition, the log event recoverer may be responsible for fetching the log data for a particular proposal on demand and serving recovery finalization workflow. The log event recoverer works on the following window/range of blocks: [latestBlock-lookbackBlocks, latestBlock-24hBlock]. In various exemplary embodiments, lookbackBlocks is 200 blocks and equal or higher than the chain's finality depth. The log recoverer may scan the log poller every second (or other suitable interval), and the log recoverer may scan logs for a subset of n=10 upkeeps, where n/2 upkeeps are randomly chosen and n/2 upkeeps are chosen by the oldest lastRePollBlock.

### Workflows

In various exemplary embodiments, smart contract automation system 100 may comprise one or more workflows. In various exemplary embodiments, workflows are the sequence of events and procedures used to determine if an upkeep is considered eligible to perform. Each workflow may perform pre-processing, processing, and/or post-processing steps. Smart contract automation system 100 may comprise conditional trigger workflows, such as a conditional proposal workflow, or a condition finalization workflow. Smart contract automation system 100 may comprise log trigger workflows, such as a log trigger workflow and a retry workflow. Smart contract automation system 100 may comprise a log recovery proposal workflow and a log recovery finalization workflow.

In various exemplary embodiments, conditional triggers may be executed using a conditional proposal workflow and a conditional finalization workflow.

In various exemplary embodiments, the conditional proposal workflow may check random samples of active upkeeps, and add the eligible upkeeps to the metadata store, denoted as proposals. The plugin may include them in the outcome, and the outcome will be added in the next round to the proposal queue to be processed by the conditional finalization workflow. A node can be temporarily down and miss some rounds and associated actions on an outcome. Accordingly, a history of coordinated proposals is kept for a suitable length, for example 20 rounds. Accordingly, a node can process coordinated proposals for up to the last 20 rounds. In various exemplary embodiments, 1 second is the expected OCR round time, so the timeout for a coordinated proposal is ˜20 seconds, which allows the node enough time to process the proposal before it gets coordinated again, on a new check block number.

In various exemplary embodiments, the conditional finalization workflow may check coordinated proposals merged with coordinated block history, from the previous round. Eligible results are added to the result store, denoted as performables. The eligible results that were agreed by at least ceiling ((n+f+1)/2)=7 nodes will be included in a report, the report signed by at least f+1=4 nodes, will be performed on chain. The report may also be referred to as a “results report.”

In various exemplary embodiments, the log triggers may be executed using a log trigger workflow, retry workflow, and log recovery proposal workflow.

In various exemplary embodiments, the log trigger workflow may check the latest logs from the log event provider, and adds the eligible results to the result store, denoted as performables. Ineligible results are reported to the upkeep states store. The results that were agreed by at least ceiling ((n+f+1)/2)=7 nodes will be included in a report, the report signed by at least f+1=4 nodes, will be performed on chain. In cases of retryable failures, the payloads are pushed into the retry queue.

In various exemplary embodiments, the retry workflow may be configured to retry payloads that failed with retryable errors. The retry workflow is similar to log trigger workflow, but instead of getting logs from the log event provider, the retry workflow receives payloads from the retry queue. The retryable errors may be retried over and over as long as they originate in a block that is newer than ‘lookbackBlocks.’ In various exemplary embodiments, logs from older blocks will be considered as missed, and are expected to be picked up by the log event recoverer.

In various exemplary embodiments, the log recovery proposal workflow may check logs that were missed and spotted by the log event recoverer. Eligible results are added to the metadata store, denoted as proposals. Ineligible results are reported to the upkeep states store. The plugin will include them in the outcome, and they will be added in the next round to the proposal queue to be processed on a coordinated check block by the log recovery finalization workflow. The log recovery proposal workflow uses the same structure as the conditional proposal workflow, where it keeps them active for, for example, 20 rounds tied to a particular coordinated check block.

In various exemplary embodiments, the log recovery finalization workflow may check coordinated proposals merged with the latest check blocks. Eligible results may be added to the result store, denoted as performables. Ineligible results may be reported to the upkeep states store. The results that were agreed by at least ceiling ((n+f+1)/2)=7 nodes will be included in a report, the report signed by at least f+1=4 nodes, will be performed on chain.

In various exemplary embodiments, the smart contract automation system 100 may use pre reporting. The OCR interface is implemented with “pure” functions that don't perform any blocking operations. Instead, the OCR interface may use a sync pooling and queueing to decouple the interaction with other components in the system including.

Proposal queue—used by the plugin for queueing proposals to be processed by the finalization observers.

Result store—used to store performable results to be included in an outcome after the plugin reads them. Finalization workflows adds results, while the plugin reads them.

Metadata store—used by proposal workflows for pushing proposals and block history to be included in an outcome after the plugin reads them.

In various exemplary embodiments, the finalized reports may be transmitted to contract, to perform the agreed upkeep payloads on chain. In various exemplary embodiments, transmit events are used to surface the results to the network. The following events can be emitted by the contract for a given report:

UpkeepPerformed: Report successfully performed for an upkeep (for log triggers (upkeepID, logldentifier)).

StateUpkeep: Report was stale and the upkeep was already performed. For conditionals this happens when an upkeep is tried to be performed on a checkBock Number which is older than the last perform block (Stale check). For log triggers, this happens when the particular (upkeepID, logIdentifier) has been performed before already.

InsufficientFunds: Emitted when pre upkeep execution when not enough funds are found on chain for the execution. Funds check is done in checkPipeline, but actual funds required on chain at execution time can change, e.g., due to gas price changes/link price changes. In such cases, upkeep is not performed or charged. These reports are typically an edge case, on chain exemplary systems and protocols have a multiplier during checkPipeline to overestimate funds before even attempting an upkeep.

CancelledUpkeep: This happens when the upkeep gets cancelled in between check time and perform time. To protect against malicious users, the contract adds a 50 block delay to any user cancellation requests.

### OCR Plugin

In various exemplary embodiments, the plugin may be configured to perform the following tasks upon OCR life cycle: (1) observation, (2) outcome, (3) reports, and/or (4) determine whether to accept or transmit a report.

In various exemplary embodiments, upon observation, the plugin may first preprocess a previous outcome, and then build the current observation. The plugin may be configured to preprocess a previous outcome, which may include one or more of the following steps: (1) remove agreed upon finalized performables from result store; (2) remove surfaced proposals from metadata store; and/or (3) add surfaced proposals to proposal queue.

In various exemplary embodiments, the plugin may be configured to build the current observation. The plugin may read performables from the result store; filter results using coordinator and add them to observation; read proposals from the metadata store; filter using coordinator and add them to observation; and/or read block history from metadata store and add it to observation. The plugin may be configured to receive proposals, perfomables, and/or block history and add the proposals, perfomables, and/or block history to observation.

In various exemplary embodiments, the OCR seq number is used as a pseudoRandom seed for sorting performables and proposals in a random, deterministic order across nodes.

In various exemplary embodiments, upon outcome, the plugin may collect performables and proposals from the other nodes observations, to be included in an outcome. The performables with ceiling ((n+f+1)/2) agreements are added to finalized results. The proposals may be collected without aforementioned amount of agreement, but with limits, deduplication, and filtering of existing proposals. The proposals may be “merged” with the coordinated block and added to the outcome. The coordinated block may be determined by looking on block history and using the most recent block and/or hash with f+1 agreement.

In various exemplary embodiments, the plugin may take agreed performables from the outcome, package them into reports with potential batching of upkeeps. Batching of upkeeps may be subject to upkeep gas limit, and preconfigured reportGasLimit and gasOverheadPerUpkeep. Additionally, same upkeep ID is not batched within the same report. In various exemplary embodiments, a set of results may use a single value for fastGasWei, linkNative, which is taken from the result which has the highest checkBlock Num.

### ShouldAcceptAttestedReport

In various exemplary embodiments, the plugin may extract [(trigger, upkeepID)] from a report and add reported upkeeps to the coordinator to be marked as inflight. The report won't be accepted if a report with a higher check block number was already accepted for the same WorkID. The same WorkID may not be already existing in coordinator, e.g., node's local chain is lagging the network. As a result, exemplary systems and protocols implement an override behaviour where the system waits on the higher checkBlockNum report.

### ShouldTransmitAcceptedReport

In various exemplary embodiments, the plugin may extract [(trigger, upkeepID)] from report filters upkeeps that were already performed using the coordinator. If any (trigger, upkeepID) is not yet confirmed then return true; otherwise return false.

### Components

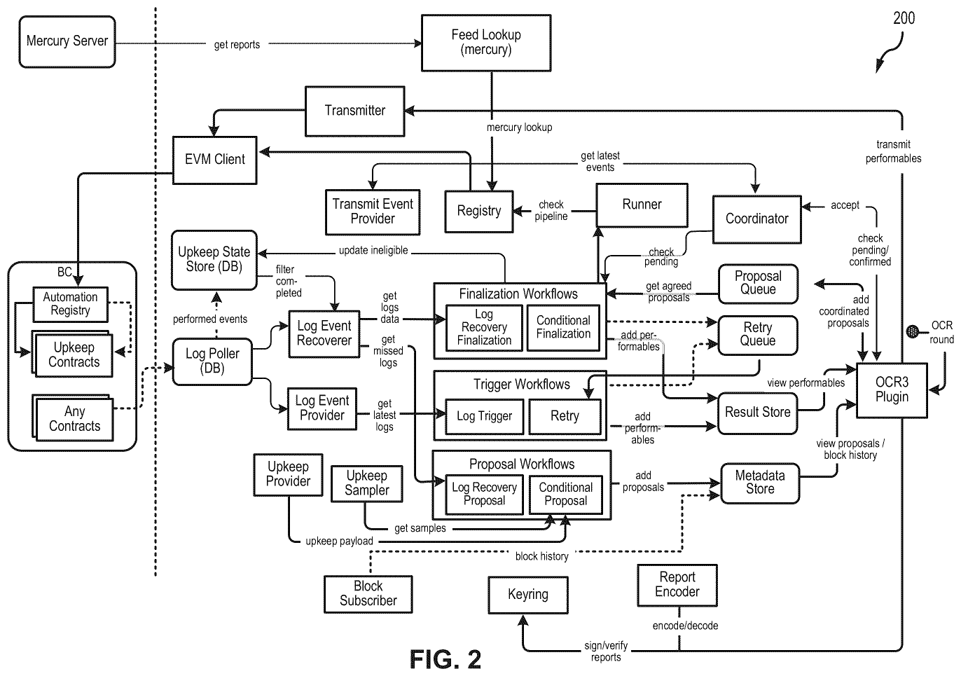

With reference now to FIG. 2, a decentralized execution engine for automating smart contracts 200 with a triggering mechanism is shown, in accordance with various exemplary embodiments. Decentralized execution engine for automating smart contracts 200 may comprise a plugin, workflows, providers, and other system components as described in detail above.

In various exemplary embodiments, a registry may connect the off-chain node with the registry on-chain. The registry may upkeep life-cycle management. For example, the registry may sync the active upkeeps and corresponding configuration on-chain with node's local state in memory. The registry may sync active upkeeps and corresponding configuration on chain by listening to the relevant events on chain for the following: upkeep registration/cancellation/migration, upkeep pause/unpause, and/or upkeep configuration changes. The registry may periodically (for example, about every 10 minutes, or about every 9 minutes, or about every 11 minutes) perform a full sync of all upkeeps on-chain state so that any potential missed/reorganized state logs are accounted for. The registry may call the log event provider in case some log filter needs to be updated. Upon startup, all upkeeps may be synced from chain and the log event provider may be called to update all the log filters.

In various exemplary embodiments, the registry may be configured to check pipeline. For example, the registry may expose checkUpkeep so the runner may execute the pipeline taking upkeepPayload as an input. If the checkBlockNum is lagging latestBlock by more than a threshold (for example, 128 blocks) then it returns a non-retryable error. The registry may, for log triggers, verify the log is still part of chain at checkBlockNum. The registry may perform a batch RPC call to checkUpkeep (for conditionals calls checkUpkeep ( ) and for log calls checkUpkeep (logData)). The registry may perform a batch mercury fetch and callback for upkeeps that requires mercury data. The registry may perform a batch RPC call to simulatePerform Upkeep for upkeeps that are eligible. The registry may return a list of results for each payload. Result can be eligible with upkeepResult/non-eligible with failure reason/error, which can be retryable if it's transient or non-retryable.

In various exemplary embodiments, a log event provider may determine the latest logs for registered upkeeps. The log event provider may store state in-memory and therefore does not maintain any state across restarts (no persistence). The log event provider may upkeep the filter life cycle. For example, the log event provider may listen in for log filter configuration changes from the registry to sync log poller and the local filter store with changes in the filters. The log event provider may provide the latest logs. For example, the log event provider may provide a simple interface getLatestPayloads to provide new unseen logs across all upkeeps within a limit. In the background, the log event provider may repeatedly query latest logs from the chain (for example, via log poller DB) for the last lookbackBlocks blocks and stores them in the log buffer. The log event provider may ‘getLatestPayloads’ wherein the log event provider might miss logs when there is a surge of logs which lasts longer than ‘lookbackBlocks.’ Upon node restarts, the log event provider can miss logs when it restarts after a gap or provide the same logs again when it quickly restarts. To mitigate missed or dropped logs, the log event recoverer may re-scan for missed logs.

In various exemplary embodiments, a log buffer may comprise a circular/ring buffer of blocks and their corresponding logs, which act as a cache for logs. The log buffer may store the last lookbackBlocks blocks, where each block holds a list of that block's logs. The logs may be marked as seen when they are returned by the buffer, to avoid working with logs that have already been seen. The log buffer may be used by the log event provider to provide unseen logs to the node.

In various exemplary embodiments, a log filter store may comprise a local store of log filters for each upkeep. The log filter store may be used by the log event provider and log event recoverer as a source of truth for the current active log filters.

In various exemplary embodiments, a log event recoverer is responsible to ensure that no logs are missed. The log event recoverer runs a background process for re-scanning of logs and putting missed logs into the recovery flow (without checkBlockNum/Hash). Logs may be considered as missed if they are older than latestBlock-lookbackBlocks and have not been performed or successfully checked already (i.e., an ineligible result). While the log event provider is scanning latest logs, the log event recoverer may scan older logs in ascending order, up to latestBlock-lookbackBlocks, newer blocks will be under the log event provider's lookback window.

In various exemplary embodiments, the log event recoverer may scan using one or more of the following steps:

The log event recoverer maintains a lastRePollBlock for each upkeep, i.e. the last block it scanned for that upkeep;

Every second (or other suitable interval), the log event recoverer may scan logs for a subset of n=10 upkeeps, where n/2 upkeeps are randomly chosen and n/2 upkeeps are chosen by the oldest lastRePollBlock (n is configurable);

The log event recoverer may start scanning from lastRePollBlock on each iteration;

Logs that are older than 24 hr are ignored, therefore lastRePollBlock starts at latestBlock—(24 hr block) in case it was not populated before; and

Once a missed log is found by the log event recoverer, the missed log is being added to a visited set, so it will not be added again. It will be removed from the visited set upon expiration (for example, 24 hours) or once it is performed and/or marked as an ineligible result.

### Proposal Data

In various exemplary embodiments, the log event recoverer may provide an interface to receive proposal data. For example, getProposalData may be called when building an upkeep payload for a particular log on demand when surfaced as a proposal from another node. In various exemplary embodiments, a payload building process may comprise one or more of the following steps:

Does not return a payload for a newer log to ensure recovery logs are isolated from latest logs;

Verifies that the log is part of the filters for that upkeep and it is still present on chain;

Checks whether the log has been already processed within the upkeepState. If so, then doesn't return a payload;

Gets the required log from log poller; and/or

Packs the log for the payload.

In various exemplary embodiments, an upkeep states store may be used to track the status of log trigger upkeeps (ineligible, performed) across the system, to avoid redundant work by the recoverer The upkeep states store may be a database or other data storage device. The upkeep states store may select, by (upkeepID, logIdentifier) used as a key, to store the state of a log upkeep. The state may be updated after an ineligible check by observer. The upkeep states store may perform events scanner updates of the states cache lazily/on-demand, for example by reading DedupKeyAdded events after finality depth which indicates the particular log upkeep was performed. The states may be persisted in the upkeep states store so the latest state to be restored when the node starts up. The nodes do not seek any agreement on ineligible state for an upkeep from the network, and as such, their local states can become inconsistent. However, the perform state may be coordinated by the chain to be the same across all nodes.

In various exemplary embodiments, a runner may be responsible for parallelizing upkeep executions and/or providing a single interface to different components maintaining a shared cache. The runner may take a list of upkeepPayloads, and calls CheckPipeline asynchronously with upkeeps being batched in a single pipeline execution. The runner may maintain in-memory cache of non-errored pipeline executions indexed on (trigger, upkeepID) and/or directly use that result instead of a new execution if available. The runner may allow for repeated calls for the same upkeep payload. In various exemplary embodiments, execution may automatically fail after a timeout that was provided as argument (for example, ˜20 s, set by workflow). A call to CheckUpkeeps on the runner may be synchronous. For example, a worker may be spawned per a batch of upkeeps to check, and all workers needs to finish before returning.

In various exemplary embodiments, due to the sync nature, pending requests may not be tracked, therefore the system may double check the same payloads. Once a payload was checked, the system may cache the result in memory, so next time it does not need to be checked again.

In various exemplary embodiments, a coordinator may store in-flight and confirmed reports in memory and help to coordinate the execution and transmission of upkeeps across multiple components in the system. The coordinator may, in various exemplary embodiments, store reports by workID, in case of conflict-when a new report is seen for the same key, the system waits on the higher checkBlockNumber. In various exemplary embodiments, all keys stored may expire after a predetermined time to live (“TTL”). In case an item is not marked as performed within TTL, it is assumed that the transmission was lost. Conditionals and log trigger upkeeps recover from such scenarios through different logic.

In various exemplary embodiments, the coordinator may assist with conditionals. The coordinator may ensure that an upkeep is performed at progressively higher blocks and tracks ‘in-flight’ status on transmits. This variant sets the last performed block higher in a local cache for an upkeepId on every transmit event.

In various exemplary embodiments, the coordinator may assist with log triggers. For example, in various exemplary embodiments, the coordinator may ensure that a triggered log is performed only once. The coordinator may track ‘in-flight’ status when a report is generated and registers transmit events to keep track of those that have been performed.

In various exemplary embodiments, the coordinator may assist with transmitting events. For example, the coordinator may listen to transmit event logs (stale/reorged/cancelled/insufficient funds) of stored workID in memory, and act accordingly:
(i) Upkeep performed-the workID is marked as confirmed;
(ii) For log trigger upkeeps, the same workID will be filtered out as it has been performed;
(iii) For conditional upkeeps the transmit block number is stored in memory and workID on lower check blocks will be filtered out;
(iv) Stale/Reorged/Insufficient funds/Cancelled report-the workID is marked as transmitted to prevent further transmissions;
(v) Conditional upkeeps are expected to be sampled and checked again automatically on a newer check block;
(vi) Missed logs are expected to be surfaced again by the recoverer on a higher check block.

### Coordinator API

In various exemplary embodiments, decentralized execution engine for automating smart contracts 200 may comprise a coordinator API for performing functions by the coordinator. The coordinator API may be configured to accept, determine whether to transmit, and/or determine whether to process.

In various exemplary embodiments, the coordinator API may allow the coordinator to expose an Accept function to mark an upkeep as pending for transmission. It is used during shouldAccept step by the plugin. If the same workID was accepted before, it allows it to be accepted on a higher check block.

In various exemplary embodiments, the coordinator API may determine whether to transmit a reported upkeep. For example, to check whether some reported upkeep can be transmitted, the plugin may call to shouldTransmit on the coordinator, and the coordinator may return true if the workID was accepted on the given checkBlock and didn't see a transmit event for it yet.

In various exemplary embodiments, the coordinator API may determine whether to process an upkeep. For example, the coordinator API may use shouldProcess (upkeepID, trigger) to check whether an upkeep should be processed which is used for pre-processing and/or filtering to prevent duplicate reports. The coordinator may return one of the following results in response to conditionals false if report is inflight for upkeepID; false if the report has been confirmed as performed after given check block number; or true otherwise.

In various exemplary embodiments, the coordinator may return one of the following results in response to log triggers: False if report is inflight or has been confirmed as performed, or true otherwise.

In various exemplary embodiments, the results store may be responsible for storing upkeepResults that a node determines should be performed. The results store may seek agreement from a quorum of nodes regarding the results to push into reports. In various exemplary embodiments, best effort is made to ensure the same logs enter different node's result stores independently, as it is assumed that blockchain nodes will get in sync within TTL, but it is not guaranteed as node's local blockchain can see different reorgs or select different logs during surges. Results that do not achieve agreement within TTL are expected to be picked up by recovery flow. In various exemplary embodiments, one or more nodes may connect to the chain independently, such that there is no central broadcasting.

In various exemplary embodiments, the results store may maintain an in-memory collection of upkeep results. The results store may store information, for example conditional upkeeps will be stored by (upkeepID) and log trigger upkeeps will be stored by (upkeepID, logIdentifier). The conditional upkeeps may overwrite results for duplicated results with newer checkBlockNumber.

In various exemplary embodiments, each result may have a TTL (for example, 5 minutes, or other suitable length of time). In various exemplary embodiments, when the TTL expires the conditional upkeeps may be sampled and checked again automatically. Further, in various exemplary embodiments, when the TTL expires the log trigger upkeeps that were missed are expected to be picked up by the log event recoverer.

In various exemplary embodiments, the results store may provide a read API to view results, which takes as input (pseudoRandomSeed, limit). The nodes in the network are expected to use the same seed for a particular round. The results store may sort all keys (trigger, upkeepID) with the seed and provide first limit results. The system may not do FIFO here, because potentially out of sync old results will block new results sent by the node for agreement.

In various exemplary embodiments, the results store may provide an API to remove (trigger, upkeepID)) from the store.

In various exemplary embodiments, the metadata store may store the metadata to be sent within observations to the network. In various exemplary embodiments, every very record bas a TTL, and upon expiry items are removed without any action. The metadata store provides an add/view/remove API for other components.

In various exemplary embodiments, the metadata store may store objects such as conditional proposals, log recovery proposals, and/or latest block history. In various exemplary embodiments, conditional proposals may comprise sample upkeeps (upkeepID) that are eligible to perform. In various exemplary embodiments, log recovery proposals may comprise recovered proposals (upkeepID, logIdentifier) that were missed, and are eligible to perform. In various exemplary embodiments, latest block history may comprise the latest block history coming from the block subscriber (for example, the last 256 block and bashes) and used for coordination among nodes.

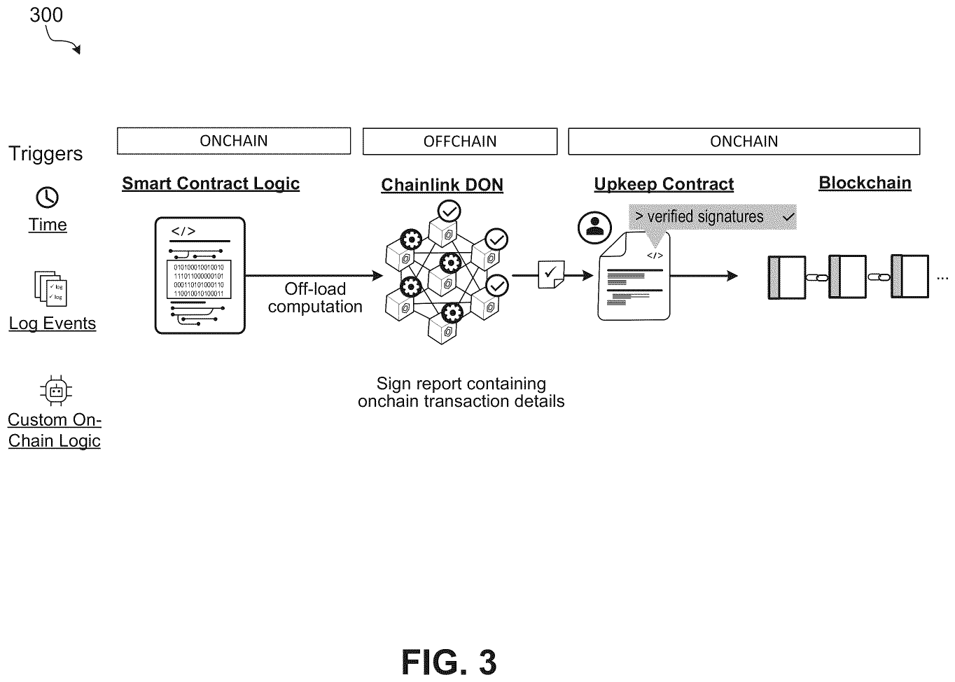

With reference now to FIG. 3, a smart contract automation system is shown in accordance with various exemplary embodiments. The smart contract automation system may comprise on-chain and off-chain components. For example, in various embodiments, and as described in detail herein, the smart contract automation system may be configured to identify triggers, such as time triggers, log event triggers, or other custom logic triggers. The smart contract automation system may comprise off chain data processing, including a distributed network of nodes. For example, in various embodiments, the decentralized network of nodes may include decentralized oracle nodes (“DON”). In various embodiments, the off chain network of decentralized nodes receives off load computation and determines verifiable data. The network of decentralized nodes may determine reportable or verifiable data based on consensus among nodes. The decentralized network of nodes may provide verified or reportable data to the upkeep contract. The upkeep contract may provide the reportable data to the blockchain.

### Solution: Chainlink Automation as a Transaction Execution Service

“Keepers” are externally owned accounts (EOAs) that are incentivized to trigger the execution of smart contracts based on predefined conditions. Conditions are defined in jobs and submitted by a development team, DAO, or protocol users to a decentralized network, along with rewards subject to performance. Conditions for smart contract automation are generally based on time (e.g., trigger x function every day at 5:00 pm EST) or events (e.g., trigger y function only when the asset's price crosses a certain threshold).

Decentralized automation nodes check conditions and make transactions once those predefined conditions have been satisfied. This process often involves the nodes using off-chain computation to execute the same smart contract function that it may eventually call on-chain. Once the function returns true, then the node calls that function on-chain by issuing an on-chain transaction. When the function is called, the conditions can be verified on-chain by the protocol's smart contract before it undergoes a state change, helping ensure that the node is correct. The end result is smart contracts that only run on blockchains when needed and according to clearly defined conditions.

Via use of exemplary systems and methods as disclosed herein, key advantages and benefits are obtained. For example, the smart contract automation systems and methods allow for automated smart contract triggering and recordation on blockchain without the need for additional intermediate steps and verification processes. The smart contract automation systems and methods are technical solutions to a technical problem applicable to existing smart contracts, namely, existing smart contracts require multiple steps and are particularly risky in implementation. The smart contract automation systems and methods technical solution includes verifiable off chain computing with cryptographic guarantees though a decentralized multi-node consensus. For example, when eligible results are identified, multiple nodes reach consensus by determining if the same eligible result was identified and is therefore a performable event. When consensus is identified, the performable event may be executed on-chain. Moreover, the smart contract automation systems and methods may comprise modules and workflows which are entirely off-chain and only read and record to the blockchain, reducing risk and increasing efficiency. Further, the smart contract automation systems and methods allow for double upkeep protection guarantees to the user. The smart contract automation systems and methods include sampling of conditional upkeeps to reduce load on the system and enable scaling, while accounting for malicious nodes in a decentralized oracle network (DON). The smart contract automation systems and methods allow for consensus on block number in a two-step process to perform conditional upkeeps. The smart contract automation systems and methods are a two pronged approach to processing log data. The smart contract automation systems and methods process the logs efficiently, and nodes independently select latest logs in a manner which maximizes chance of consensus. The log recovery mechanisms of the smart contract automation systems and methods are a backup process which ensures logs are not missed.

Additional principles of the present disclosure are set forth in the following materials:

“Chainlink Automation 2.0′s Verifiable Compute—A Leap Forward for Web3 Computation” 12 Jan. 2024 (available at https://blog.chain.link/chainlink-automation-verifiable-compute/);

“Build the Next Generation of Dapps With Automation V2” presented by De Clercq Wentzel at SmartCon2023 (video file, 12:16 duration, available at https://www.youtube.com/watch?v=bQT-txThTAE).

“Offchain protocol overview v2.1” available at https://github.com/smartcontractkit/chainlink-automation/blob/d6eaaa217e6ecacce9893c51c9f0cdb263340636/docs/PROTOCOL_v21.md

“EVM Log Triggers” available at https://github.com/smartcontractkit/chainlink-automation/blob/d6eaaa217e6ecacce9893c51c9f0cdb263340636/docs/LOG_TRIGGERS.md

In addition to all the foregoing, principles of the present disclosure may be compatible with, complimentary to, and/or utilized in connection with principles set forth in:

U.S. Ser. No. 16/553,292 filed Aug. 28, 2019, entitled “Systems, Methods, and Storage Media for Interfacing At Least One Smart Contract Stored On A Decentralized Architecture With External Data Sources,” now U.S. Pat. No. 11,854,101;

U.S. Ser. No. 17/471,035 filed on Sep. 9, 2021, entitled “Computer Network Transaction Sequencing Method and System”;

U.S. Ser. No. 17/678,769 filed on Feb. 23, 2022, entitled “Method and Apparatus for Providing Secure Information to a Decentralized Computing Environment”; and

U.S. Ser. No. 18/207,888 filed on Jun. 9, 2023, entitled “Method and Apparatus for Producing Verifiable Randomness Within a Decentralized Computing Network.”

The contents of each of the foregoing materials and applications are incorporated herein by reference in their entirety for all purposes, but except for any subject matter disclaimers or disavowals, and except to the extent that the incorporated material is inconsistent with the express disclosure herein, in which case the language in this disclosure shall control.

For the sake of brevity, conventional database management, network communication, computer networking, data compression, error checking, and other aspects of exemplary systems and methods (and components thereof) may not be described in detail herein. Furthermore, the connecting lines shown in the various figures contained herein are intended to represent functional relationships and/or physical or communicative couplings between the various elements. It should be noted that many alternative or additional functional relationships or physical connections may be present in a practical system of consensus or related methods.

While the description references specific technologies, system architectures and data management techniques, practitioners will appreciate that this description is of various exemplary embodiments, and that other devices and/or methods may be implemented without departing from the scope of principles of the present disclosure.

While the steps outlined herein represent exemplary embodiments of principles of the present disclosure, practitioners will appreciate that there are many suitable computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods, and computer program products are provided. In the detailed description herein, references to “various exemplary embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement principles of the disclosure in alternative embodiments.

For example, the steps recited in any of the method or process descriptions may be executed in any suitable order and are not limited to the order presented. Moreover, any of the functions or steps may be outsourced to or performed by one or more third parties Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F.3d 1338, 1342-43 (Fed. Cir. 2008)). For example, the description or claims may refer to a processor for convenience, but principles of the disclosure contemplate that the processor may be multiple processors. The multiple processors may handle separate tasks or combine to handle certain tasks. Although specific advantages have been enumerated herein, various exemplary embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B: (5) at least one of B and at least one of C: (6) at least one of A and at least one of C; or (7) at least one of A, at least one of B, and at least one of C.

What is claimed is:

1. A smart contract automation system comprising:
one or more processors configured by machine-readable instructions to:
receive, by the smart contract automation system, a log data;
provide, by an upkeep provider, an upkeep payload to a workflow, the upkeep payload comprising one or more active upkeeps;
determine, by the proposal workflow, whether the one or more active upkeeps is an eligible upkeep;
determine, by the smart contract automation system, a reportable result based on the eligible upkeep and the log data; and
transmit, by the smart contract automation system, the reportable result to a blockchain.

2. The smart contract automation system of claim 1, wherein the one or more processors are further configured by the machine-readable instructions to:
receive, by a log event provider, the log data;
provide, by the log event provider, the log data to a trigger workflow; and
determine, by the trigger workflow, an eligible result, the eligible result based on the log data.

3. The smart contract automation system of claim 2, wherein the one or more processors are further configured by the machine-readable instructions to:
receive, by a results store, the eligible result; and
determine, by the results store, the reportable result based on the eligible result.

4. The smart contract automation system of claim 1, wherein the determining the reportable result further comprises agreeing, by two or more nodes, an eligible result, wherein each of the two or more nodes determines the eligible result.

5. The smart contract automation system of claim 1, wherein the one or more processors are further configured by the machine-readable instructions to:
check, by smart contract automation system, a condition associated with the blockchain;
trigger, by smart contract automation system, a conditional trigger based on the condition; and
execute, by smart contract automation system, a transaction based on the conditional trigger.

6. The smart contract automation system of claim 1, wherein the one or more processors are further configured by the machine-readable instructions to:
store, by the smart contract automation system, the log data in a database; and
transmit, by the database, the log data to one or more workflows, the workflows including the proposal workflow.

7. The smart contract automation system of claim 1, wherein the one or more processors are further configured by the machine-readable instructions to:
receive, by a results store, the eligible result and a block reference; and
store, by the results store, the eligible result and the block reference.

8. A method of smart contract automation, comprising:
triggering, by a processor, a conditional trigger based on a condition of a blockchain;
receiving, by the processor, a verifiable data in response to the conditional trigger;
determining, by the processor, a recordable transaction based on the verifiable data;
agreeing, by the processor and a processor of one or more nodes in a network of nodes, the recordable transaction is agreed to; and
executing, by the processor, a smart contract, wherein the smart contract is based on the recordable transaction.

9. The method of smart contract automation of claim 8, wherein the verifiable data comprises a data log.

10. The method of smart contract automation of claim 8, further comprising:
identifying, by the processor, whether an active upkeep is eligible; and
proving, by the processor, an eligible upkeep, wherein the eligible upkeep is based on the verifiable data.

11. The method of smart contract automation of claim 8, wherein the agreeing, by the processor and a processor of one or more nodes, the recordable transaction is agreed to, is based on consensus across the one or more nodes.

12. A smart contract automation system, comprising:
a processor; and
a tangible, non-transitory memory configured to communicate with the processor, the tangible, non-transitory memory having instructions stored thereon that, in response to execution by the processor, cause the processor to perform operations comprising:
polling, by a log poller, a log data associated with a blockchain;
storing, by the log poller, the log data in a database;
determining, by one or more workflows, a performable event based on the log data;
agreeing, by one or more nodes, a reportable result based on the performable event; and
recording the reportable result on the blockchain.

13. The system of claim 12, further comprising:
providing, by an upkeep provider, an upkeep payload to one or more of the workflows, the upkeep payload comprising one or more active upkeeps;
determine, by one or more workflow, whether the one or more active upkeeps is an eligible upkeep; and
determine, by the smart contract automation system, the reportable result further based on the eligible upkeep.

14. The system of claim 12, wherein the one or more processors are further configured to:
receive, by a log event provider, the log data;
provide, by the log event provider, the log data to a trigger workflow; and
determine, by the trigger workflow, an eligible result, the eligible result based on the log data, and the reportable result is further based on the eligible result.

15. The system of claim 12, wherein the one or more processors are further configured to:
receive, by a results store, an eligible result; and
determine, by the results store, the reportable result based on the eligible result.

16. The system of claim 12, wherein the one or more processors are further configured to: agreeing, by two or more nodes, an eligible result, wherein each of the two or more nodes determines the eligible result independently, the reportable result based on the eligible result.

17. The system of claim 16, wherein the eligible result is the performable event.

18. The system of claim 12, wherein the one or more processors are further configured by the machine-readable instructions to:
check, by smart contract automation system, a condition associated with the blockchain;
trigger, by smart contract automation system, a conditional trigger based on the condition; and
execute, by smart contract automation system, a transaction based on the conditional trigger.

19. The system of claim 12, wherein the one or more processors are further configured to:
transmit the log data from the database to the one or more workflows, the workflows including a proposal workflow.

20. The system of claim 12, wherein the one or more processors are further configured to:
sample, by an upkeep sampler, one or more of the workflows.
